(19) United States
(12) Patent Application Publication
(10) Pub. No.: US 2025/0305879 A1
(43) Pub. Date: Oct. 2, 2025

(54) SPECTRUM MEASUREMENT INSTRUMENT, LASER DEVICE, AND METHOD OF IDENTIFYING PEAK POSITION OF REFERENCE LIGHT

(71) Applicant: Gigaphoton Inc., Tochigi (JP)

(72) Inventors: Masato MORIYA, Oyama-shi (JP); Keisuke ISHIDA, Oyama-shi (JP)

(73) Assignee: Gigaphoton Inc., Tochigi (JP)

(21) Appl. No.: 19/232,835

(22) Filed: Jun. 9, 2025

Related U.S. Application Data
(63) Continuation of application No. PCT/JP2023/000974, filed on Jan. 16, 2023.

(51) Int. Cl. G01J 3/28; G01J 3/02; G01J 3/10; G01J 3/12

(52) U.S. Cl. CPC G01J 3/2823; G01J 3/0297; G01J 3/10; G01J 2003/1226; G01J 2003/2859

(57) ABSTRACT

A spectrum measurement instrument is configured to measure a wavelength of pulse laser light and includes a mercury lamp configured to encapsulate natural mercury including a plurality of isotopes and output reference light; a spectrometer located on an optical path of the reference light and the laser light and configured to receive the reference light and output a first spectral waveform; and a processor being accessible to a template waveform of a spectrum including a plurality of peaks of a known waveform of the reference light, and configured to perform pattern matching using the first spectral waveform and the template waveform and identify a first peak position corresponding to one of the plurality of peaks of the first spectral waveform.

### CROSS-REFERENCE TO RELATED APPLICATIONS

The present application is a continuation application of International Application No. PCT/JP2023/000974, filed on Jan. 16, 2023, the entire contents of which are hereby incorporated by reference.

### BACKGROUND

### 1. Technical Field

The present disclosure relates to a spectrum measurement instrument, a laser device, and a method of identifying a peak position of reference light.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 5,243,614
Patent Document 2: Japanese Patent Application Publication No. H05-167168
Patent Document 3: U.S. Pat. No. 5,748,316
Patent Document 4: US Patent Application Publication No. 2019/107438

### SUMMARY

A spectrum measurement instrument according to an aspect of the present disclosure is configured to measure a wavelength of pulse laser light and includes a mercury lamp configured to encapsulate natural mercury including a plurality of isotopes and output reference light; a spectrometer located on an optical path of the reference light and the laser light and configured to receive the reference light and output a first spectral waveform; and a processor being accessible to a template waveform of a spectrum including a plurality of peaks of a known waveform of the reference light, and configured to perform pattern matching using the first spectral waveform and the template waveform and identify a first peak position corresponding to one of the plurality of peaks of the first spectral waveform.

A laser device according to an aspect of the present disclosure includes a spectrum measurement instrument including a mercury lamp configured to encapsulate natural mercury including a plurality of isotopes and output reference light; a spectrometer located on an optical path of the reference light and laser light and configured to receive the reference light and output a first spectral waveform; and a processor being accessible to a template waveform of a spectrum including a plurality of peaks of a known waveform of the reference light, and configured to perform pattern matching using the first spectral waveform and the template waveform and identify a first peak position corresponding to one of the plurality of peaks of the first spectral waveform.

A method of identifying a peak position of reference light according to an aspect of the present disclosure includes acquiring a first spectral waveform as causing the reference light output from a mercury lamp encapsulating natural mercury including a plurality of isotopes to enter a spectrometer, reading a template waveform of a spectrum including a plurality of peaks of a known wavelength of the reference light, and performing pattern matching using the first spectral waveform and the template waveform and identifying a first peak position corresponding to one of the plurality of peaks of the first spectral waveform.

### BRIEF DESCRIPTION OF THE DRAWINGS

Embodiments of the present disclosure will be described below merely as examples with reference to the accompanying drawings.

FIG. 1 schematically shows the configuration of an exposure system of a comparative example.

FIG. 2 schematically shows the configuration of a laser device according to the comparative example.

FIG. 3 is a flowchart of wavelength control processing in the comparative example.

FIG. 4 is a flowchart showing details of processing of detecting interference fringes of reference light shown in FIG. 3.

FIG. 5 is a graph showing an example of a waveform of the interference fringes of the reference light.

FIG. 6 is a flowchart showing details of processing of detecting the interference fringes of laser light shown in FIG. 3.

FIG. 7 is a graph showing an example of the waveform of the interference fringes of the reference light when a mercury lamp encapsulating natural mercury is used as a light source.

FIG. 8 is a graph showing a resonant wavelength of each of a plurality of isotopes contained in natural mercury and a relative light amount for each resonant wavelength.

FIG. 9 schematically shows the configuration of the laser device according to a first embodiment.

FIG. 10 is a flowchart showing details of the processing of detecting the interference fringes of the reference light in the first embodiment.

FIG. 11 is a flowchart showing details of the processing of calculating a matching position shown in FIG. 10.

FIG. 12 is a graph for explaining the processing of obtaining the center position of the interference fringes of the reference light.

FIG. 13 is a graph for explaining the processing of obtaining the center position of the interference fringes of the reference light.

FIG. 14 is a graph for explaining the processing of obtaining the center position of the interference fringes of the reference light.

FIG. 15 is a graph for explaining the processing of obtaining the center position of the interference fringes of the reference light.

FIG. 16 is a graph showing a waveform using the center position of the interference fringes of the reference light as the origin.

FIG. 17 is a graph showing an example of a deformed waveform transformed into a wavelength coordinate system.

FIG. 18 is a graph showing a first example in a state in which a template waveform is superimposed on the deformed waveform shown in FIG. 17.

FIG. 19 is a graph showing a second example in a state in which the template waveform is superimposed on the deformed waveform shown in FIG. 17.

FIG. 20 is a graph showing a normalized cross-correlation function between the deformed waveform shown in FIG. 17 and the template waveform.

FIG. 21 is a graph in which the waveform of the normalized cross-correlation function and the template waveform are superimposed.

FIG. 22 is a graph showing another example of the deformed waveform transformed into the wavelength coordinate system.

FIG. 23 is a graph showing a state in which the template waveform is superimposed on the deformed waveform shown in FIG. 22.

FIG. 24 is a graph showing a normalized cross-correlation function between the deformed waveform shown in FIG. 22 and the template waveform.

FIG. 25 shows the configuration of the mercury lamp used in the laser device according to a second embodiment.

FIG. 26 shows the configuration of the mercury lamp used in the laser device according to the second embodiment.

FIG. 27 is a graph showing relationships between mercury vapor pressures and light emission times from the start of light emission of the mercury lamp including a getter material and the mercury lamp without the getter material.

FIG. 28 is a graph showing relationships between light amounts and light emission times from the start of light emission of the mercury lamp including the getter material and the mercury lamp without the getter material.

FIG. 29 shows a waveform of the interference fringes of the reference light generated using the mercury lamp including the getter material.

FIG. 30 shows a waveform of the interference fringes of the reference light generated using the mercury lamp including the getter material.

FIG. 31 shows a waveform of the interference fringes of the reference light generated using the mercury lamp in a poor state without the getter material.

FIG. 32 is a processing of detecting the interference fringes of the flowchart showing details of the reference light in a third embodiment.

FIG. 33 is a flowchart showing details of the processing of detecting the interference fringes of the reference light in the third embodiment.

FIG. 34 is a flowchart showing details of the processing of calculating the matching position in a fourth embodiment.

FIG. 35 is a graph for explaining a method of extracting a partial waveform.

FIG. 36 is a graph for explaining a method of updating the template waveform using the partial waveform.

### DESCRIPTION OF EMBODIMENTS

### <Contents>

1. Comparative example
   1.1 Configuration of exposure apparatus 100
   1.2 Operation of exposure apparatus 100
   1.3 Configuration of laser device 1
      1.3.1 Laser oscillator 20
      1.3.2 Spectrum measurement instrument 16
   1.4 Operation
      1.4.1 Laser control processor 30
      1.4.2 Laser oscillator 20
      1.4.3 Spectrum measurement instrument 16
      1.4.4 Wavelength measurement processor 50
      1.4.5 Wavelength control
         1.4.5.1 Detection of interference fringes of reference light
         1.4.5.2 Detection of interference fringes of laser light
   1.5 Problem of comparative example
2. Spectrum measurement instrument 16 measuring interference fringes of reference light as performing pattern matching
   2.1 Configuration
   2.2 Operation
      2.2.1 Calculation of matching position (Rhg)²
         2.2.1.1 Determination of center position of interference fringes of reference light
         2.2.1.2 Transformation into wavelength coordinate system
         2.2.1.3 Cross-correlation function with respect to template wavelength T (i)
         2.2.1.4 Identifying of matching position
      2.2.2 Treatment for collapsed waveform
   2.3 Operation
3. Spectrum measurement instrument 16 including mercury lamp 18n encapsulating natural mercury and getter material
   3.1 Configuration
   3.2 Effect
4. Spectrum measurement instrument 16 with improved SN ratio
   4.1 Operation
      4.1.1 Acquiring background waveform
      4.1.2 Improvement ratio due to integration of interference fringes of reference light
      4.1.3 Improvement of SN ratio due to subtraction of background waveform
      4.1.4 Pattern matching
   4.2 Effect
5. Spectrum measurement instrument 16 updating template waveform T (i)
   5.1 Operation
   5.2 Effect
6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

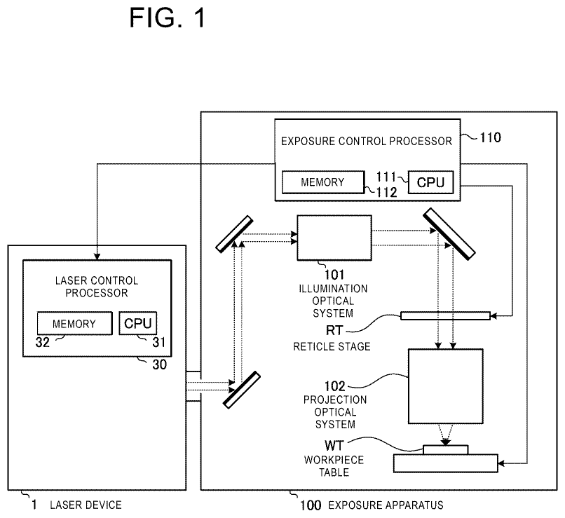

FIG. 1 schematically shows the configuration of an exposure system according to a comparative example. The comparative example of the present disclosure is an example recognized by the applicant as known only by the applicant, and is not a publicly known example admitted by the applicant. The exposure system includes a laser device 1 and an exposure apparatus 100. The laser device 1 includes a laser control processor 30. The laser control processor 30 is a processing device including a memory 32 in which a control program is stored, and a central processing unit (CPU) 31 which executes the control program. The laser control processor 30 is specifically configured or programmed to perform various processes included in the present disclosure. The laser control processor 30 configures the processor in the present disclosure. The laser device 1 is configured to output laser light toward the exposure apparatus 100.

1.1 Configuration of exposure apparatus 100

The exposure apparatus 100 includes an illumination optical system 101, a projection optical system 102, and an exposure control processor 110. The illumination optical system 101 illuminates a reticle pattern of a reticle (not shown) arranged on a reticle stage RT with laser light incident from the laser device 1. The projection optical system 102 causes the laser light transmitted through the reticle to be imaged as being reduced and projected on a workpiece (not shown) arranged on a workpiece table WT. The workpiece is a photosensitive substrate such as a semiconductor wafer on which a resist film is applied.

The exposure control processor 110 is a processing device including a memory 112 in which the control program is stored and a CPU 111 which executes the control program. The exposure control processor 110 is specifically configured or programmed to perform various processes included in the present disclosure. The exposure control processor 110 performs overall control of the exposure apparatus 100 and transmits and receives various data and various signals to and from the laser control processor 30.

1.2 Operation of exposure apparatus 100

The exposure control processor 110 transmits setting data of a target wavelength and a target pulse energy, and a trigger signal to the laser control processor 30. The laser control processor 30 controls the laser device 1 in accordance with these data and signals. The exposure control processor 110 synchronously translates the reticle stage RT and the workpiece table WT in opposite directions to each other. Thus, the workpiece is exposed to the laser light reflecting the reticle pattern.

Through the exposure process as described above, the reticle pattern is transferred onto the semiconductor wafer. Thereafter, an electronic device can be manufactured through a plurality of processes.

1.3 Configuration of laser device 1

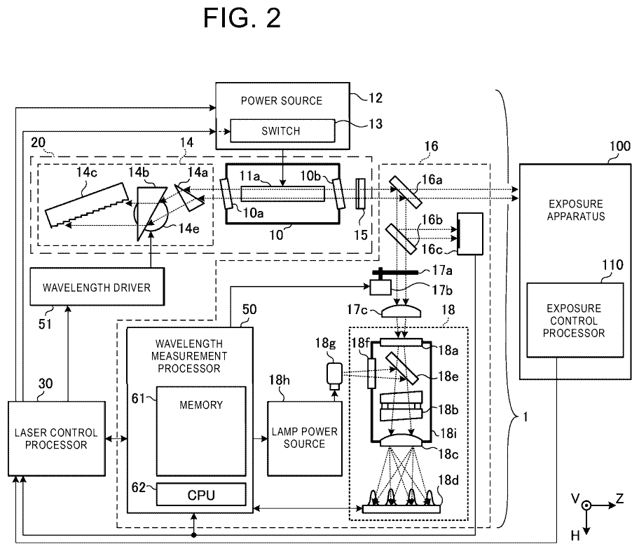

FIG. 2 schematically shows the configuration of the laser device 1 according to the comparative example. The laser device 1 includes a laser oscillator 20, a spectrum measurement instrument 16, and the laser control processor 30. The laser device 1 is connectable to the exposure apparatus 100.

1.3.1 Laser oscillator 20

The laser oscillator 20 includes a laser chamber 10, a discharge electrode 11a, a power source 12, a line narrowing module 14, and an output coupling mirror 15.

The line narrowing module 14 and the output coupling mirror 15 configure a laser resonator. The laser chamber 10 is arranged on the optical path of the laser resonator. Windows 10a, 10b are arranged at both ends of the laser chamber 10. The discharge electrode 11a and a discharge electrode (not shown) paired with the discharge electrode 11a are arranged inside the laser chamber 10. The discharge electrode (not shown) is positioned so as to overlap with the discharge electrode 11a in a V-axis direction perpendicular to the paper surface. The laser chamber 10 is filled with a laser gas containing, for example, a krypton gas as a rare gas, a fluorine gas as a halogen gas, a neon gas as a buffer gas, and the like.

The power source 12 includes a switch 13 and is connected to the discharge electrode 11a and a charger (not shown).

The line narrowing module 14 includes a plurality of prisms 14a, 14b and a grating 14c. The prisms 14a, 14b are arranged in this order on the optical path of the light output from the window 10a. The surfaces of the prisms 14a, 14b on and from which the light is incident and exits are both parallel to the V axis. The prism 14b is supported by a rotation stage 14e. The rotation stage 14e is connected to a wavelength driver 51. The grating 14c is arranged on the optical path of the light having transmitted through the prisms 14a, 14b. The direction of grooves of the grating 14c is parallel to the V axis.

The output coupling mirror 15 is a partial reflection mirror in which a partial reflection film is coated on one surface and a reflection suppression film is coated on the other surface.

1.3.2 Spectrum measurement instrument 16

The spectrum measurement instrument 16 is arranged on the optical path of the laser light between the output coupling mirror 15 and the exposure apparatus 100. The spectrum measurement instrument 16 includes beam splitters 16a, 16b, an energy sensor 16c, a shutter 17a, a light concentrating lens 17c, a spectrometer 18, a mercury lamp 18g, a lamp power source 18h, and a wavelength measurement processor 50. The wavelength measurement processor 50 corresponds to the processor in the present disclosure.

The beam splitter 16a is located on the optical path of the laser light output from the output coupling mirror 15. The beam splitter 16a is configured to transmit a part of the laser light toward the exposure apparatus 100 at high transmittance and to reflect other parts thereof. The beam splitter 16b is located on the optical path of the laser light reflected by the beam splitter 16a. The energy sensor 16c is located on the optical path of the laser light reflected by the beam splitter 16b. The energy sensor 16c is configured of a photodiode, a photoelectric tube, or a pyroelectric element.

The shutter 17a is located on the optical path of the laser light transmitted through the beam splitter 16b. The shutter 17a is capable of being switched between an open state and a closed state by an actuator 17b.

The light concentrating lens 17c is located on the optical path of the laser light having passed through the shutter 17a in the open state. The shutter 17a in the closed state does not allow the laser light to pass therethrough and prevents the laser light from reaching the light concentrating lens 17c.

The mercury lamp 18g is a hot-cathode type low-pressure mercury lamp encapsulating mercury whose rate of an isotope having a mass number of 202 is 90% or more. The mercury lamp 18g is configured to output reference light while receiving power from the lamp power source 18h. The reference light output by the mercury lamp 18g contains a large amount of wavelength components of about 253.7 nm.

The spectrometer 18 is located on the optical path of the laser light transmitted through the light concentrating lens 17c and the reference light output by the mercury lamp 18g so that the laser light and the reference light enter the spectrometer 18. The spectrometer 18 includes a diffusion plate 18a, an etalon 18b, a light concentrating lens 18c, a line sensor 18d, a beam splitter 18e, a filter 18f, and a housing 18i. The etalon 18b and the beam splitter 18e are arranged in the housing 18i. The diffusion plate 18a, the light concentrating lens 18c, and the filter 18f are attached to the housing 18i.

The diffusion plate 18a is located on the optical path of the laser light concentrated by the light concentrating lens 17c. The diffusion plate 18a has a number of irregularities on the surface thereof and is configured to transmit and diffuse the laser light from the outside to the inside of the housing 18i.

The filter 18f is a bandpass filter that transmits the wavelength components of the reference light emitted by the mercury lamp 18g. The filter 18f is configured to transmit the reference light from the outside to the inside of the housing 18i.

The beam splitter 18e is arranged at a position where the optical path of the laser light transmitted through the diffusion plate 18a intersects the optical path of the reference light transmitted through the filter 18f. The beam splitter 18e is configured to transmit the laser light including a wavelength component of about 248.4 nm and reflect the reference light including a wavelength component of about 253.7 nm.

The laser light transmitted through the beam splitter 18e and the reference light reflected by the beam splitter 18e have substantially the same divergence angle. Both of the above enter the etalon 18b through substantially the same optical path.

The etalon 18b includes two partial reflection mirrors. The two partial reflection mirrors face each other with an air gap of a predetermined distance therebetween, and are bonded to each other with a spacer interposed therebetween. Each of the partial reflection mirrors has a predetermined reflectance with respect to the laser light including the wavelength component of about 248.4 nm and the reference light including the wavelength component of about 253.7 nm. The light concentrating lens 18c is located on the optical path of the laser light and the reference light transmitted through the etalon 18b.

The line sensor 18d is located on the optical path of the laser light and the reference light transmitted through the light concentrating lens 18c and on the focal plane of the light concentrating lens 18c. The line sensor 18d is a light distribution sensor including a large number of light receiving elements arranged in one dimension. Alternatively, instead of the line sensor 18d, a photodiode array may be used, or an image sensor including a large number of light receiving elements arranged in two dimensions may be used.

The line sensor 18d receives interference fringes formed by the etalon 18b and the light concentrating lens 18c. The interference fringes are an interference pattern of the laser light or the reference light having a concentric circle shape, and a square of the distance from the center of the concentric circle is proportional to a change in the wavelength. The waveform of the interference fringes is also referred to as a fringe waveform.

The line sensor 18d is configured to transmit, to the wavelength measurement processor 50, waveform data of the interference fringes formed by the etalon 18b and the light concentrating lens 18c. The line sensor 18d may detect an integrated light amount obtained by temporally integrating a light amount in each of the light receiving elements, and may use the integrated waveform indicating the distribution of the integrated light amount as the waveform data of the interference fringes.

The wavelength measurement processor 50 is a processing device including a memory 61 in which a control program is stored and a CPU 62 which executes the control program. The wavelength measurement processor 50 is specifically configured or programmed to perform various processes included in the present disclosure.

In the present disclosure, the laser control processor 30 and the wavelength measurement processor 50 are described as separate components. However, the laser control processor 30 may also serve as the wavelength measurement processor 50.

### 1.4 Operation

### 1.4.1 Laser Control Processor 30

The laser control processor 30 transmits setting data of an application voltage to be applied to the discharge electrode 11a to the power source 12 based on the setting data of the target pulse energy received from the exposure control processor 110. The laser control processor 30 transmits a drive signal to the wavelength driver 51 based on the setting data of the target wavelength received from the exposure control processor 110. Further, the laser control processor 30 transmits, to the switch 13 included in the power source 12, an oscillation trigger signal based on the trigger signal received from the exposure control processor 110.

### 1.4.2 Laser Oscillator 20

The switch 13 is turned on when the oscillation trigger signal is received from the laser control processor 30. When the switch 13 is turned on, the power source 12 generates a pulse high voltage from the electric energy charged in the charger (not shown), and applies the high voltage to the discharge electrode 11a.

When the high voltage is applied to the discharge electrode 11a, discharge occurs in the laser chamber 10. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width of the light output through the window 10a of the laser chamber 10 is expanded by the prisms 14a, 14b, and then the light is incident on the grating 14c. The light incident on the grating 14c from the prisms 14a, 14b is reflected by a plurality of grooves of the grating 14c and is diffracted in a direction corresponding to the wavelength of the light. The prisms 14a, 14b reduce the beam width of the diffracted light from the grating 14c and return the light to the laser chamber 10 through the window 10a.

The output coupling mirror 15 transmits and outputs a part of the light output through the window 10b of the laser chamber 10, and reflects the other part back into the laser chamber 10 through the window 10b.

In this way, the light output from the laser chamber 10 reciprocates between the line narrowing module 14 and the output coupling mirror 15, and is amplified each time the light passes through the discharge space in the laser chamber 10. The light is line narrowed each time being turned back in the line narrowing module 14. Thus, the light having undergone laser oscillation and line narrowing in the laser oscillator 20 is output as the laser light from the output coupling mirror 15.

The rotation stage 14e included in the line narrowing module 14 rotates the prism 14b about an axis parallel to the V axis in accordance with a drive signal output from the wavelength driver 51. By rotating the prism 14b, the selected wavelength of the line narrowing module 14 is adjusted and the center wavelength of the laser light is adjusted.

### 1.4.3 Spectrum Measurement Instrument 16

The energy sensor 16c detects the pulse energy of the laser light and outputs data of the pulse energy to the laser control processor 30 and the wavelength measurement processor 50. The data of the pulse energy is used by the laser control processor 30 to perform feedback control on the setting data of the application voltage to be applied to the discharge electrode 11a. An electric signal including the data of the pulse energy can be used by the wavelength measurement processor 50 to count the number of pulses of the laser light.

The spectrometer 18 generates waveform data of the interference fringes from the light amount in each of the light receiving elements included in the line sensor 18d that has received the interference fringes.

### 1.4.4 Wavelength Measurement Processor 50

The wavelength measurement processor 50 controls opening and closing of the shutter 17a by the actuator 17b. Further, the wavelength measurement processor 50 controls turning on and off of the mercury lamp 18g by the lamp power source 18h. For acquiring the waveform of the interference fringes of the reference light, the wavelength measurement processor 50 closes the shutter 17a and turns on the mercury lamp 18g. Thereafter, the wavelength measurement processor 50 outputs a data output trigger to the line sensor 18d. Then, the wavelength measurement processor 50 receives the waveform data of the interference fringes output from the line sensor 18d. Thus, the waveform data of the interference fringes of the reference light having a known specific wavelength is acquired.

For measuring the wavelength of the laser light, the wavelength measurement processor 50 turns off the mercury lamp 18g and opens the shutter 17a. The wavelength measurement processor 50 receives a measurement signal of the pulse energy from the energy sensor 16c, counts the number of pulses of the laser light, and transmits the data output trigger to the line sensor 18d for each fixed integrated pulse number. Then, the wavelength measurement processor 50 receives the waveform data of the interference fringes output from the line sensor 18d. Thus, the waveform data of the interference fringes of the laser light having an unknown wavelength is acquired. The wavelength measurement processor 50 calculates an absolute wavelength λabs of the laser light based on the radius of the interference fringes of the laser light and the radius of the interference fringes of the reference light.

The wavelength measurement processor 50 transmits the calculation result of the absolute wavelength λabs of the laser light to the laser control processor 30. The laser control processor 30 transmits a control signal to the wavelength driver 51 based on the absolute wavelength λabs of the laser light received from the wavelength measurement processor 50 and the setting data of the target wavelength λt received from the exposure control processor 110. The rotation stage 14e of a holder that supports the prism 14b is driven by the wavelength driver 51 and the prism 14b is rotated about an axis parallel to the V direction, so that the incident angle of the incident light on the grating 14c is changed, and the selected wavelength is changed.

### 1.4.5 Wavelength Control

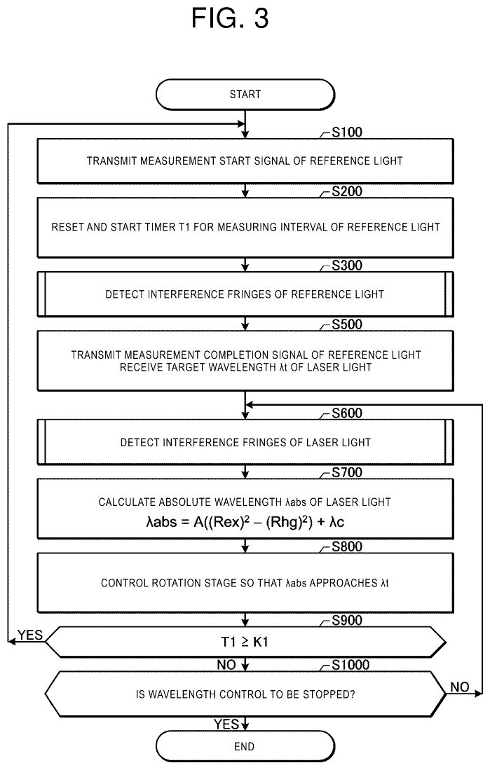

FIG. 3 is a flowchart of wavelength control processing in the comparative example. Through the processing described below, the wavelength measurement processor 50 calculates the absolute wavelength λabs of the laser light by measuring the interference fringes of the reference light and the interference fringes of the laser light, and the laser control processor 30 performs feedback control on the center wavelength of the laser light.

In S100, the wavelength measurement processor 50 transmits a measurement start signal of the reference light to the laser control processor 30. The laser control processor 30 transmits a signal permitting the start of measuring the reference light to the wavelength measurement processor 50. Upon receiving a signal permitting the start of measuring the reference light, the wavelength measurement processor 50 advances processing to S200.

In S200, the wavelength measurement processor 50 resets and starts a timer T1 for measuring the measurement interval of the reference light.

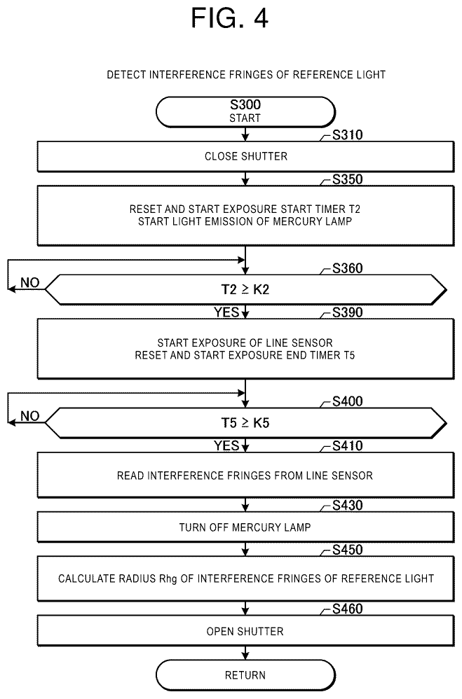

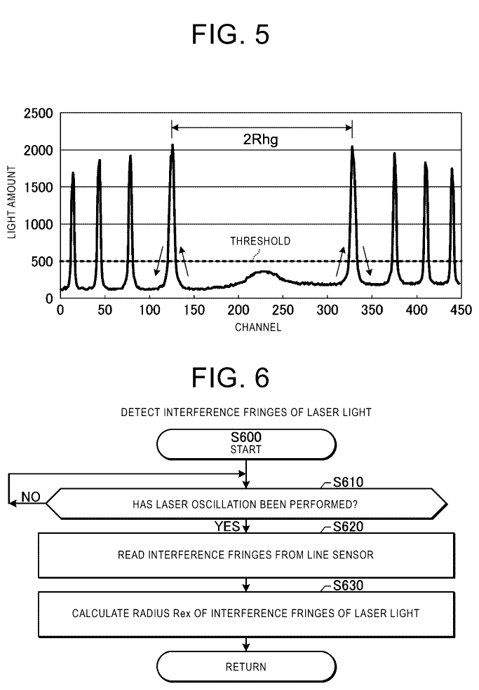

In S300, the wavelength measurement processor 50 detects the interference fringes of the reference light and calculates the radius Rhg of the interference fringes of the reference light. Details of the process in S300 will be described later with reference to FIGS. 4 and 5.

In S500, the wavelength measurement processor 50 transmits a measurement completion signal of the reference light to the laser control processor 30. Further, the laser control processor 30 receives the setting data of the target wavelength λt of the laser light from the exposure control processor 110.

In S600, the wavelength measurement processor 50 detects the interference fringes of the laser light, and calculates a radius Rex of the interference fringes of the laser light from a peak position of the interference fringes of the laser light. The interference fringes of the laser light correspond to the second spectral waveform in the present disclosure, and the peak position of the interference fringes of the laser light corresponds to the second peak position in the present disclosure. Details of the process in S600 will be described later with reference to FIG. 6.

In S700, the wavelength measurement processor 50 calculates the absolute wavelength λabs of the laser light by the following expression, and transmits the calculation result to the laser control processor 30.

λabs=A((Rex)²−(Rhg)²)+λc

Here, λc is an offset wavelength, and is a constant corresponding to the absolute wavelength of the laser light when the radius Rex of the interference fringes of the laser light and the radius Rhg of the interference fringes of the reference light are equal to each other. A is a positive number given as a proportional constant. When (Rex)² and (Rhg)² are given on a wavelength scale, the proportional constant A is 1.

In S800, the laser control processor 30 receives the absolute wavelength λabs of the laser light from the wavelength measurement processor 50, and calculates a difference Δλ between the absolute wavelength λabs and the target wavelength λt of the laser light by the following expression.

Δλ=λabs−λt

The laser control processor 30 controls the rotation stage 14e so that the difference AA approaches zero. In this way, the laser control processor 30 feedback-controls the center wavelength of the laser light so that the absolute wavelength λabs approaches the target wavelength λt.

In S900, the wavelength measurement processor 50 determines whether or not the value of the timer T1 has reached a threshold K1. When the value of the timer T1 has not reached the threshold K1 (S900:NO), the wavelength measurement processor 50 advances processing to S1000. In S1000, the wavelength measurement processor 50 determines whether or not wavelength control is to be stopped. When the wavelength control is to be stopped (S1000:YES), the wavelength measurement processor 50 ends processing of the flowchart. When the wavelength control is not to be stopped (S1000:NO), the wavelength measurement processor 50 returns processing to S600.

When the value of the timer T1 has reached the threshold K1 (S900:YES), the wavelength measurement processor 50 returns processing to S100 and updates the radius Rhg of the interference fringes of the reference light by performing the subsequent processes.

As described above, the frequency of detecting the interference fringes of the reference light may be lower than the frequency of detecting the interference fringes of the laser light. The threshold K1 set as the cycle for detecting the interference fringes of the reference light may be 5 minutes or more. The threshold K1 may be one or more days and one week or less as long as the characteristics of the etalon 18b are stable.

### 1.4.5.1 Detection of Interference Fringes of Reference Light

FIG. 4 is a flowchart showing details of the processing of detecting the interference fringes of the reference light shown in FIG. 3. The processing shown in FIG. 4 is performed by the wavelength measurement processor 50 as a subroutine of S300 shown in FIG. 3.

In S310, the wavelength measurement processor 50 controls the actuator 17b so that the shutter 17a is closed and entering of the laser light is limited.

In S350, the wavelength measurement processor 50 starts light emission of the mercury lamp 18g by controlling the lamp power source 18h as resetting and starting a timer T2 that measures the time from the start of light emission of the mercury lamp 18g to the start of exposure of the line sensor 18d.

In S360, the wavelength measurement processor 50 determines whether or not the value of the timer T2 has reached a threshold K2. The threshold K2 may be, for example, 0.5 second or more and 2 seconds or less. When the value of the timer T2 has not reached the threshold K2 (S360:NO), the wavelength measurement processor 50 waits until the value of the timer T2 reaches the threshold K2. When the value of the timer T2 has reached the threshold K2 (S360:YES), the wavelength measurement processor 50 advances processing to S390.

In S390, the wavelength measurement processor 50 starts the exposure of the line sensor 18d and resets and starts a timer T5 for measuring the time until the exposure of the line sensor 18d ends.

In S400, the wavelength measurement processor 50 determines whether or not the value of the timer T5 has reached a threshold K5. The threshold K5 may be, for example, 2 seconds or more and 3 seconds or less. When the value of the timer T5 has not reached the threshold K5 (S400:NO), the wavelength measurement processor 50 waits until the value of the timer T5 reaches the threshold K5, and causes the exposure of the line sensor 18d to be continued. When the value of the timer T5 has reached the threshold K5 (S400:YES), the wavelength measurement processor 50 advances processing to S410.

In S410, the wavelength measurement processor 50 outputs the data output trigger to the line sensor 18d. Thus, the wavelength measurement processor 50 ends the exposure of the line sensor 18d. Further, the wavelength measurement processor 50 reads data of the interference fringes of the reference light from the line sensor 18d.

In S430, the wavelength measurement processor 50 controls the lamp power source 18h to turn off the mercury lamp 18g.

In S450, the wavelength measurement processor 50 calculates the radius Rhg of the interference fringes of the reference light based on the data of the interference fringes.

The square of the radius Rhg of the interference fringes of the reference light is used to calculate the absolute wavelength λabs of the laser light in S700 of FIG. 3.

In S460, the wavelength measurement processor 50 controls the actuator 17b to open the shutter 17a. Thereafter, the wavelength measurement processor 50 ends processing of the flowchart, and returns to the processing of FIG. 3.

FIG. 5 is a graph showing an example of the waveform of the interference fringes of the reference light. In FIG. 5, the horizontal axis represents the channel number, and the vertical axis represents the light amount. The channel number corresponds to the position of each of the light receiving elements included in the line sensor 18d. The light amount is indicated by a count number. When the concentric interference fringes are measured by the line sensor 18d, a substantially symmetrical waveform is obtained.

In the waveform of the interference fringes of the reference light shown in FIG. 5, the radius Rhg of the interference fringes is calculated as follows, for example. Data of the light amount is scanned rightward from the approximate center position of the interference fringes, and a first point that upwardly crosses a threshold and a second point that downwardly crosses the threshold are identified as a pair. In FIG. 5, a right-upward arrow is shown in the vicinity of the first point, and a right downward arrow is shown in the vicinity of the second point. Similarly, data of the light amount is scanned leftward from the approximate center position of the interference fringes, and a third point that upwardly crosses the threshold and a fourth point that downwardly crosses the threshold are identified as a pair. In FIG. 5, a left-upward arrow is shown in the vicinity of the third point, and a left-downward arrow is shown in the vicinity of the fourth point.

Since the distance between the position where the light amount becomes a peak between the first point and the second point and the position where the light amount becomes a peak between the third point and the fourth point corresponds to twice the radius Rhg of the interference fringes of the reference light, the radius Rhg can be calculated based on this distance.

### 1.4.5.2 Detection of Interference Fringes of Laser Light

FIG. 6 is a flowchart showing details of the processing of detecting the interference fringes of the laser light shown in FIG. 3. The processing shown in FIG. 6 is performed by the wavelength measurement processor 50 as a subroutine of S600 shown in FIG. 3.

In S610, the wavelength measurement processor 50 determines whether or not laser oscillation has been performed. Whether or not the laser oscillation has been performed is determined based on, for example, whether or not the wavelength measurement processor 50 has received an electric signal generated when the energy sensor 16c detects the pulse energy of the laser light.

In S620, the wavelength measurement processor 50 outputs the data output trigger to the line sensor 18d. Accordingly, the wavelength measurement processor 50 receives the data of the interference fringes corresponding to one pulse of the laser light from the line sensor 18d. Alternatively, the wavelength measurement processor 50 may be configured to cause the exposure of the line sensor 18d to be continued for a predetermined period of time, and receive the data of the interference fringes obtained by integrating the light amount in each of the light receiving elements over a plurality of pulses included in the laser light.

In S630, the wavelength measurement processor 50 calculates the radius Rex of the interference fringes of the laser light based on the data of the interference fringes. The method of calculating the radius Rex of the interference fringes of the laser light may be similar to that described with reference to FIG. 5. The square (Rex)² of the radius of the interference fringes of the laser light is used in S700 of FIG. 3 to calculate the absolute wavelength λabs of the laser light. Thereafter, the wavelength measurement processor 50 ends the processing of the flowchart, and returns to the processing of FIG. 3.

### 1.5 Problem of Comparative Example

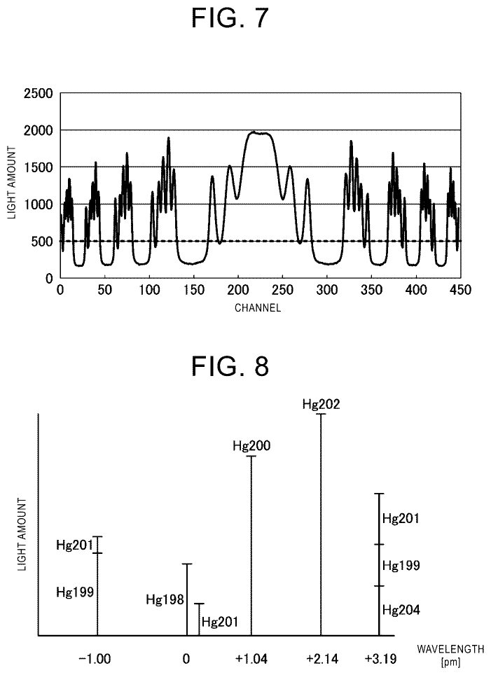

FIG. 7 is a graph showing an example of the waveform of the interference fringes of the reference light when a mercury lamp encapsulating natural mercury is used as a light source. FIG. 8 is a graph showing the resonant wavelength of each of a plurality of isotopes contained in natural mercury and the relative light amount for each resonant wavelength. The numerical value on the horizontal axis in FIG. 8 indicates the wavelength difference between the resonant wavelength of another isotopic mercury with respect to the resonant wavelength of the isotopic mercury having the mass number of 198. Natural mercury contains six stable isotopes at an error component ratio of about 1% or less. The spectrum of the resonant wavelength of natural mercury is observed as five peaks in the spectrometer 18, which cannot distinguish the resonant wavelengths of isotopic mercury with mass numbers of 198 and 201.

The high purity isotopic mercury used in the mercury lamp 18g in the comparative example is expensive to produce, and tends to have limited availability because of its low global output.

On the other hand, when natural mercury is used, it is difficult to identify peak positions of the interference fringes. For example, when the threshold of the light amount described with reference to FIG. 5 is changed, which peak of the five peaks falls between the first point and the second point or between the third point and the fourth point is changed, and the radius Rhg of the interference fringes to be measured is also changed. Even if the threshold of the light amount is constant, when the light amount of the interference fringes is changed or noise is introduced, the radius Rhg of the interference fringes to be measured is changed, and therefore, accurate measurement cannot be performed by the conventional detection method.

Embodiments described below relate to accurately identifying peak positions from a spectral waveform of the reference light emitted from a mercury lamp encapsulating natural mercury containing a plurality of isotopes.

### 2. Spectrum Measurement Instrument 16 Measuring Interference Fringes of Reference Light as Performing Pattern Matching

### 2.1 Configuration

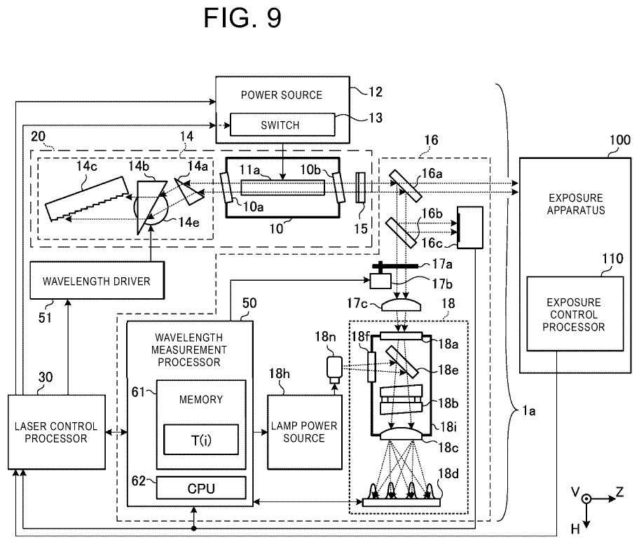

FIG. 9 schematically shows the configuration of a laser device 1a according to a first embodiment. In the laser device 1a according to the first embodiment, a mercury lamp 18n in which natural mercury including a plurality of isotopes is encapsulated is used as a light source for outputting the reference light. Here, the wavelength measurement processor 50 can access a template waveform T (i) stored in the memory 61. The template waveform T (i) is a waveform of a spectrum including a plurality of peaks of a known wavelength of the reference light, and is generated based on the spectral waveform of the reference light. For example, the template waveform T (i) may be created for each spectrometer 18 based on the waveform of the interference fringes of the reference light measured using a specific spectrometer 18. Alternatively, the template waveform T (i) may be created by averaging the waveforms of the interference fringes of the reference light measured by the plurality of spectrometers 18 with the peaks of the waveforms overlapped to each other so that the template waveform T (i) can also be used for different spectrometers 18. The template waveform T (i) is not limited to being stored in the memory 61, and the wavelength measurement processor 50 may access the template waveform T (i) stored in another storage device.

### 2.2 Operation

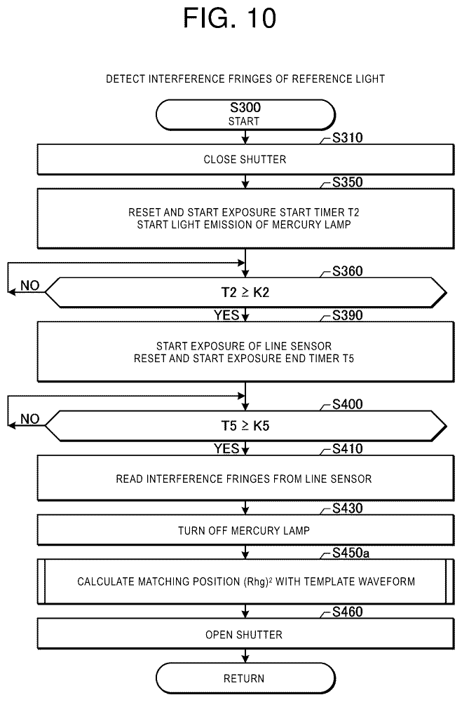

FIG. 10 flowchart showing is a details of the processing of detecting the interference fringes of the reference light in the first embodiment. The processing shown in FIG. 10 is performed by the wavelength measurement processor 50 as a subroutine of S300 shown in FIG. 3. The processes from S310 to S430 and S460 are similar to the processes of the comparative example described with reference to FIG. 4, and the process of S450a of FIG. 10 is performed instead of S450 of FIG. 4.

In S450a, the wavelength measurement processor 50 calculates a matching position (Rhg)² between the template waveform T (i) and a deformed waveform I (m) obtained by deforming the waveform of the interference fringes of the reference light into a waveform corresponding to a wavelength coordinate system. The relationship between the square (Rhg)² of the radius of the interference fringes of the reference light in the comparative example described with reference to FIG. 3 and the matching position (Rhg)² will be described later. In the first embodiment, the matching position (Rhg)² is used to calculate the absolute wavelength λabs of the laser light in S700 of FIG. 3.

### 2.2.1 Calculation of Matching Position (Rhg)²

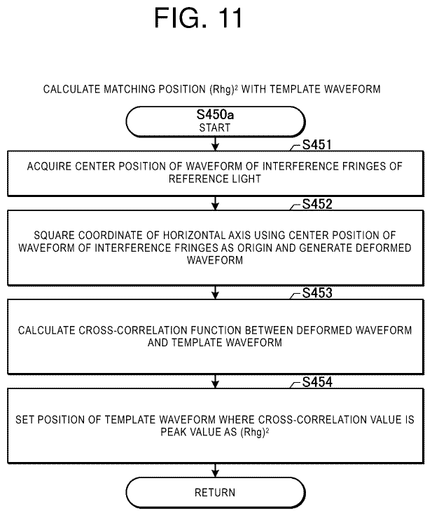

FIG. 11 is a flowchart showing details of the processing of calculating the matching position (Rhg)² shown in FIG. 10. The processing shown in FIG. 11 is performed by the wavelength measurement processor 50 as a subroutine of S450a shown in FIG. 10.

### 2.2.1.1 Determination of Center Position of Interference Fringes of Reference Light

In S451, the wavelength measurement processor 50 calculates the center position of the interference fringes of the reference light so that the waveform of the interference fringes of the reference light is deformed into the deformed waveform I (m) corresponding to the wavelength coordinate system. The center position of the interference fringes of the reference light is obtained by using pattern matching as follows.

FIGS. 12 to 15 are graphs for explaining the process of obtaining the center position of the interference fringes of the reference light. FIG. 12 corresponds to a graph obtained by plotting a division position for obtaining the center position to the graph similar to FIG. 7. As shown in FIG. 12, the division position is set in the waveform of the interference fringes of the reference light. The initial value of the channel number at the division position is S. The initial value S is set to, for example, a channel number slightly smaller than a half of the maximum value of the channel number. That is, the position slightly shifted to the left side from the center of the line sensor 18d is set as the initial value S of the division position.

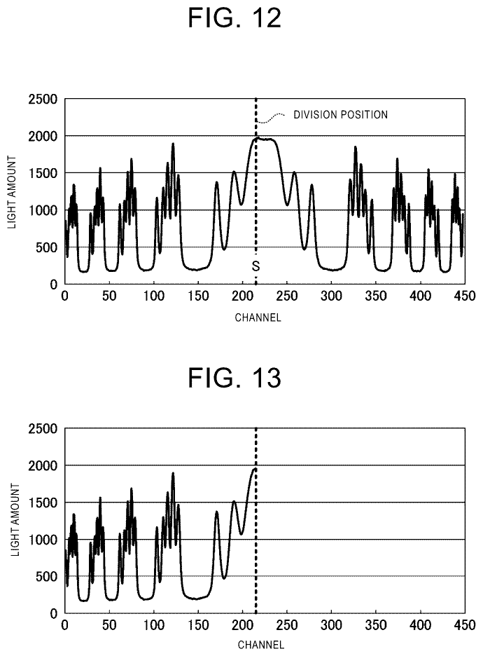

FIGS. 13 and 14 are graphs each showing an individual waveform when the waveform shown in FIG. 12 is divided into two at the division position. FIG. 13 shows a first portion that is a waveform on the left side of the division position, and FIG. 14 shows a second portion that is a waveform on the right side of the division position. In FIG. 14, the coordinate of the horizontal axis is transformed such that the coordinate of the left end of the second portion is 0. That is, the coordinate in FIG. 14 corresponds to the channel number obtained by subtracting the channel number at the division position from the channel number in FIG. 12.

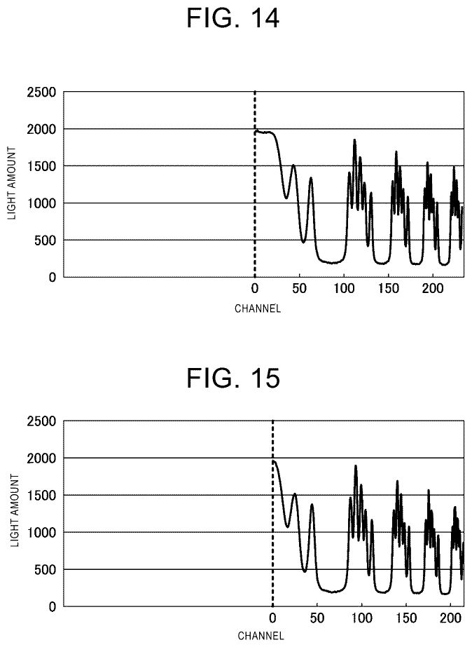

FIG. 15 is a graph showing an inverted first portion which is a waveform obtained by laterally inverting the first portion shown in FIG. 13. In FIG. 15, the coordinate of the horizontal axis is transformed such that the coordinate of the left end of the inverted first portion is 0 and the coordinate of the right end is the channel number at the division position. That is, the coordinate in FIG. 15 corresponds to a value obtained by subtracting the channel number at the division position from the coordinate in FIG. 13 and multiplying by −1.

The wavelength measurement processor 50 calculates a cross-correlation value between the second portion shown in FIG. 14 and the inverted first portion shown in FIG. 15. As the cross-correlation value, for example, any of a normalized cross-correlation (NCC), a zero-mean normalized cross-correlation (ZNCC), a sum of squares of differences (SSD), and a sum of absolute values of differences (SAD), which will be described later, can be used. The larger the calculated cross-correlation value is, the higher the degree of coincidence between the two waveforms is.

Further, the wavelength measurement processor 50 newly calculates the cross-correlation value between the second portion and the inverted first portion by shifting the correspondence relationship between the coordinate of the second portion and the coordinate of the inverted first portion by, for example, one channel. Shifting the correspondence relationship between the coordinate of the second portion and the coordinate of the inverted first portion by one channel corresponds to shifting the division position in FIG. 12 by 0.5 channel. The wavelength measurement processor 50 calculates the cross-correlation value when the waveform of the interference fringes is divided at each division position and laterally inverted while shifting the division position rightward by 0.5 channel. That is, a cross-correlation function indicating a change in the cross-correlation value in accordance with the division position is acquired. The division position where the cross-correlation value is a peak value is the center position of the interference fringes. By obtaining the division position where the cross-correlation value is a peak value in units smaller than 0.5 channel by interpolation, the accuracy can be further improved.

The description has been provided on a case in which the channel number at a position slightly shifted to the left side from the center of the line sensor 18d is set as the initial value S, and the cross-correlation value is calculated while the division position is shifted to the right. However, the calculation order of the correlation value may be other than the above. When the peak of the cross-correlation value cannot be obtained even if the division position is shifted within a predetermined range, an error signal may be output. Further, in a case in which the optical alignment of the spectrometer 18 is sufficiently stable, after the center position of the interference fringes of the reference light is once obtained, the process in S451 may be omitted thereafter in executing the processing of the present flowchart.

2.2.1.2 Transformation into Wavelength Coordinate System

Referring back to FIG. 11, in S452, the wavelength measurement processor 50 squares the coordinate of the horizontal axis of the interference fringes using the center position of the interference fringes of the reference light as the origin, and transforms the coordinate into the deformed waveform I (m) corresponding to the wavelength coordinate system.

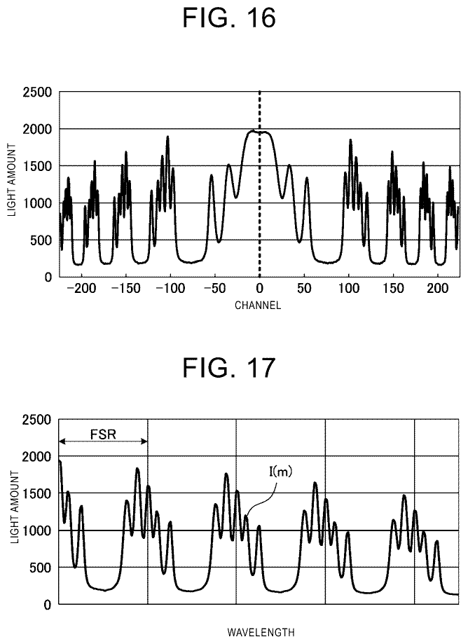

FIG. 16 is a graph showing a waveform using the center position of the interference fringes of the reference light as the origin. The coordinate in FIG. 16 corresponds to the channel number obtained by subtracting the channel number of the center position obtained in S451 from the channel number in FIG. 12.

FIG. 17 is a graph showing an example of the deformed waveform I (m) transformed into the wavelength coordinate system. In FIG. 17, the coordinate of the right half of the horizontal axis in FIG. 16 may be squared or the coordinate of the left half of the horizontal axis may be squared. By deforming in accordance with the distance from the center position of the interference fringes, the horizontal axis and the wavelength can be made to correspond to each other. One scale interval on the horizontal axis in FIG. 17 corresponds to a free spectral range (FSR) of the etalon 18b. The left end in FIG. 17 corresponds to the center position of the interference fringes, and the right end corresponds to one of both ends of the interference fringes. At the time of transforming into the wavelength coordinate system, it is desirable to obtain a smooth curve by interpolation such as linear interpolation, spline interpolation, Lorentz approximation, and the like. The waveform of the interference fringes shown in FIG. 16 and the deformed waveform I (m) shown in FIG. 17 are waveforms both indicating the spectrum of the reference light, and correspond to the first spectral waveform in the present disclosure.

2.2.1.3 Cross-Correlation Function with Respect to Template Wavelength T (i)

Referring back to FIG. 11, in S453, the wavelength measurement processor 50 reads the template waveform T (i) from the memory 61 and calculates the cross-correlation function between the deformed waveform I (m) transformed into the wavelength coordinate system and the template waveform T (i).

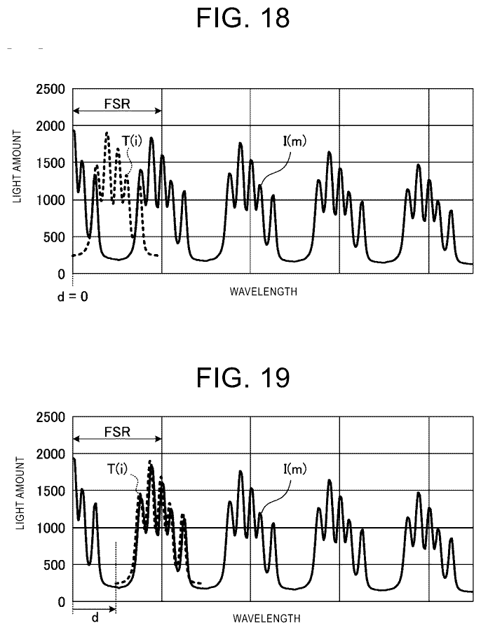

FIG. 18 is a graph showing a first example in a state in which the template waveform T (i) is superimposed on the deformed waveform I (m) shown in FIG. 17, and FIG. 19 is a graph showing a second example. A shift amount d of the template waveform T (i) is different between FIGS. 18 and 19. The cross-correlation value between the deformed waveform I (m) and the template waveform T (i) is higher in the case shown in FIG. 19 than in the case shown in FIG. 18. When the cross-correlation value is calculated while shifting the template waveform T (i) along the horizontal axis of the de formed wave form I (m), a cross-correlation function indicating a change in the cross-correlation value according to the shift amount d of the template waveform T (i) is obtained.

FIG. 20 is a graph showing a normalized cross-correlation function R_{NCC} (d) between the deformed waveform I (m) shown in FIG. 17 and the template waveform T (i). In FIG. 20, the horizontal axis represents the shift amount d of the template waveform T (i).

As the cross-correlation value, for example, any one of normalized cross-correlation (NCC), zero-mean normalized cross-correlation (ZNCC), sum of squares of differences (SSD), and sum of absolute values of differences (SAD) can be used, and the cross-correlation functions R_{NCC} (d), R_{ZNCC} (d), R_{SSD} (d), and R_{SAD} (d) each indicating the change in the cross-correlation value according to the shift amount d are defined as follows.

$${R}_{NCC} ( d ) = \frac{{\sum }_{i = 1}^{N} I ( d + i ) T ( i )}{\sqrt{{\sum }_{i = 1}^{N} {I ( d + i )}^{2} \times {\sum }_{i = 1}^{N} {T ( i )}^{2}}} \qquad [ Expression 1 ]$$

$${R}_{ZNCC} ( d ) = \frac{{\sum }_{i = 1}^{N} ( I ( d + i ) - Iavg ) ( T ( i ) - Tavg )}{\sqrt{{\sum }_{i = 1}^{N} {( I ( d + i ) - Iavg )}^{2} \times {\sum }_{i = 1}^{N} {( T ( i ) - Tavg )}^{2}}}$$

$${R}_{SSD} ( d ) = {\sum }_{i = 1}^{N} {( I ( d + i ) - T ( i ) )}^{2}$$

$${R}_{SAD} ( d ) = {\sum }_{i = 1}^{N} \vert I ( d + i ) - T ( i ) \vert$$

Here, Iavg is an average value of the deformed waveform I (m) of the reference light transformed into the wavelength coordinate system, and Tavg is an average value of the template waveform T (i).

Since the light amount of the deformed waveform I (m) decreases as the distance from the center position of the interference fringes increases as shown in FIG. 17, there is a possibility that the cross-correlation value also decreases as the distance from the center position of the interference fringes increases. However, when normalized cross-correlation (NCC) or zero-mean normalized cross-correlation (ZNCC) is used, the decrease in the cross-correlation value may be gradual even if the distance from the center position of the fringes increases. Here, to indicate that it is possible to detect the peak of the cross-correlation value even when the distance from the center position of the interference fringes increases, the result of calculating the cross-correlation value over substantially the entire horizontal axis of the deformed waveform I (m) is shown. However, if a specific number of the peaks of the cross-correlation value can be detected, calculation of the cross-correlation value may be discontinued in the middle.

### 2.2.1.4 Identifying of Matching Position

Referring back to FIG. 11, in S454, the wavelength measurement processor 50 sets, as the matching position (Rhg)², the position of the template-waveform T (i) where the cross-correlation value is the peak value. The value of (Rhg)² thus obtained is used to calculate the absolute wavelength λabs of the laser light in S700 of FIG. 3. The absolute wavelength λabs of the laser light is calculated based on the matching position (Rhg)² and the square (Rex)² of the radius of the interference fringes of the laser light. After S454, the wavelength measurement processor 50 ends the processing of the flowchart and returns to the processing shown in FIG. 10.

Referring back to FIG. 20, the position of the template waveform T (i) where the cross-correlation value is the peak value will be described. The cross-correlation values are scanned rightward from the left end in FIG. 20, and the pair of the first point that upwardly crosses the threshold and the second point that downwardly crosses the threshold is identified. The position where the cross-correlation value is the peak value between the first point and the second point is identified as the matching position (Rhg)².

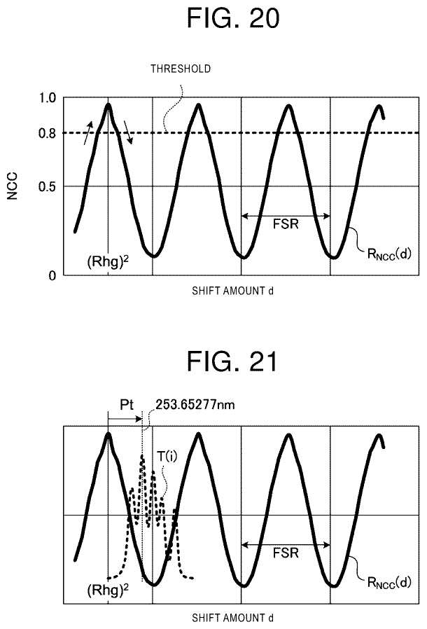

FIG. 21 is a graph in which the waveform of the normalized cross-correlation function R_{NCC} (d) and the template waveform T (i) are superimposed. The position of the left end of the template waveform T (i) coincides with the peak position of the cross-correlation value, and this position is identified as the matching position (Rhg)².

The template waveform T (i) includes a plurality of peaks of a known wavelength of the reference light, and a distance Pt from the left end of the template waveform T (i) to the position of the peak of 253.65277 nm, which is the resonant wavelength of the isotope having the mass number of 202, can be calculated at the time when the template waveform T (i) is created. Therefore, by identifying the matching position (Rhg)² by the process in S454, it is possible to identify the position (Rhg)²+Pt of the peak of the wavelength 253.65277 nm in the deformed waveform I (m) of the reference light transformed into the wavelength coordinate system. The position of the peak of the wavelength 253.65277 nm corresponds to the first peak position in the present disclosure.

Instead of the square (Rhg)² of the radius Rhg of the interference fringes of the reference light in the comparative example, corresponding to the use of the matching position (Rhg)² in the first embodiment, definition of the offset wavelength λc is different between the comparative example and the first embodiment. In the comparative example, the offset wavelength λc is defined as the absolute wavelength of the laser light when the radius Rex of the interference fringes of the laser light and the radius Rhg of the interference fringes of the reference light are equal to each other, but in the first embodiment, the offset wavelength λc is defined as the absolute wavelength of the laser light when the square (Rex)² of the radius of the interference fringes of the laser light and the matching position (Rhg)² are equal to each other. The difference between the offset wavelength λc in the comparative example and the offset wavelength λc in the first embodiment corresponds to a value obtained by converting the distance Pt into a value of the wavelength.

### 2.2.2 Treatment for Collapsed Waveform

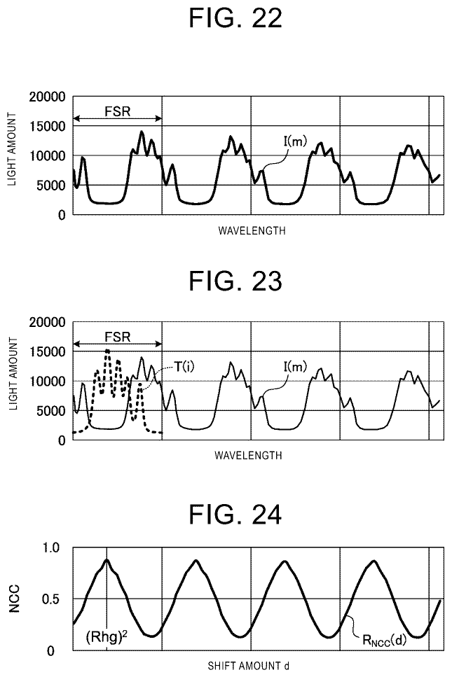

FIG. 22 is a graph showing another example of the deformed waveform I (m) transformed into the wavelength coordinate system. The deformed waveform I (m) shown in FIG. 22 does not clearly represent the five peaks as compared with the deformed waveform I (m) shown in FIG. 17 as being a collapsed waveform. If the etalon 18b has a low finesse or is noisy for some reason, the waveform as shown in FIG. 22 may be obtained.

FIG. 23 is a graph showing a state in which the template waveform T (i) is superimposed on the deformed waveform I (m) shown in FIG. 22, and FIG. 24 is a graph showing d a normalized cross-correlation function R_{NCC} (d) between the deformed waveform I (m) shown in FIG. 22 and the template waveform T (i). The deformed waveform I (m) shown in FIG. 22 appears to be significantly different in shape from the template waveform T (i), but the peak interval of the five peaks and the ratio of the respective light amounts are similar to the template waveform T (i). Therefore, in the normalized cross-correlation function R_{NCC} (d) shown in FIG. 24, peaks appearing for each free spectral range become clear, and the matching position (Rhg)² can be clearly identified. Therefore, even in the deformed waveform I (m) as shown in FIG. 22, the matching position (Rhg)² can be identified by pattern matching with the template waveform T (i).

### 2.3 Operation

(1) According to the first embodiment, the spectrum measurement instrument 16 for measuring the wavelength of the laser light includes: the mercury lamp 18n in which natural mercury including a plurality of isotopes is encapsulated and which outputs reference light; the spectrometer 18 which is located on the optical path of the reference light and the laser light and which outputs the waveform of the interference fringes of the reference light; and the wavelength measurement processor 50 which is accessible to the template waveform T (i) of the spectrum including the plurality of peaks of the known wavelength of the reference light, performs pattern matching using the waveform of the interference fringes of the reference light and the template waveform T (i), and identifies the position (Rhg)²+Pt of the peak corresponding to one of the plurality of peaks.

Further, a method of identifying a peak position of reference light according to the first embodiment includes acquiring the waveform of the interference fringes of the reference light as causing the reference light output from the mercury lamp 18n encapsulating natural mercury including the plurality of isotopes to enter the spectrometer 18; reading the template waveform T (i) of the spectrum including the plurality of peaks of the known wavelength of the reference light; and performing pattern matching using the waveform of the interference fringes of the reference light and the template waveform T (i) and identifying the peak position (Rhg)²+Pt corresponding to one of the plurality of peaks.

Accordingly, the position (Rhg)²+Pt of the peak corresponding to the known wavelength 253. 65277 nm can be accurately identified by performing pattern matching using the waveform of the interference fringes of the reference light having a plurality of peaks corresponding to the resonant wavelengths of the plurality of isotopes and the template waveform T (i).

(2) According to the first embodiment, the spectrometer 18 outputs the waveform of the interference fringes of the reference light formed using the etalon 18b, and the wavelength measurement processor 50 deforms the waveform of the interference fringes of the reference light by transforming the waveform of the interference fringes of the reference light into the deformed waveform I (m) corresponding to the wavelength coordinate system, and identifies the peak position (Rhg)²+P by identifying the matching position (Rhg)² of the deformed waveform I (m) matched to the template waveform T (i).

Accordingly, it is possible to efficiently identify the position (Rhg)²+Pt of the peak by transforming the waveform of the interference fringes whose scale changes in accordance with the distance from the center into the deformed waveform I (m) in the wavelength coordinate system and performing pattern matching with the template waveform T (i).

(3) According to the first embodiment, the wavelength measurement processor 50 determines the center position of the interference fringes of the reference light based on the cross-correlation function between the inverted first portion and the second portion obtained by dividing the waveform of the interference fringes of the reference light into the first portion and the second portion and inverting the first portion, and transforms the waveform of the interference fringes of the reference light in accordance with the distance from the center position.

Accordingly, by inverting the first portion and examining the relationship with respect to the second portion, the symmetry between the two portions can be evaluated to determine the center position of the waveform of the interference fringes, and the waveform of the interference fringes can be transformed.

(4) According to the first embodiment, the wavelength measurement processor 50 determines the center position based on the cross-correlation value between the inverted first portion and the second portion.

Accordingly, the center position of the waveform of the interference fringes can be calculated by using the cross-correlation value.

(5) According to the first embodiment, the wavelength measurement processor 50 acquires the relationship between the division position for dividing the waveform of the interference fringes of the reference light into two portions and the cross-correlation value, and determines the center position based on the relationship.

Accordingly, the center position of the waveform of the interference fringes can be obtained with high accuracy from the relationship between the division position and the cross-correlation value.

(6) According to the first embodiment, the wavelength measurement processor 50 identifies the matching position (Rhg)² based on the cross-correlation value between the deformed waveform I (m) and the template waveform T (i).

Accordingly, the matching position (Rhg)² can be calculated by using the cross-correlation value.

(7) According to the first embodiment, the wavelength measurement processor 50 acquires the relationship between the shift amount d between the deformed waveform I (m) and the template waveform T (i) and the cross-correlation value, and identifies the matching position (Rhg)² based on the relationship.

Accordingly, the matching position (Rhg)² can be obtained with high accuracy from the relationship between the shift amount d between the deformed waveform I (m) and the template waveform T (i) and the cross-correlation value.

(8) According first to the embodiment, the spectrometer 18 outputs the waveform of the interference fringes of the laser light, and the wavelength measurement processor 50 measures the absolute wavelength λabs of the laser light based on the matching position (Rhg)² and the peak position in the waveform of the interference fringes of the laser light.

Accordingly, since the peak position corresponding to the known wavelength of the reference light can be identified by the matching position (Rhg)², the absolute wavelength λabs of the laser light can be calculated based on the matching position (Rhg)² and the peak position in the waveform of the interference fringes of the laser light.

(9) According the embodiment, the to first spectrometer 18 outputs the waveform of the interference fringes of the laser light, and the wavelength measurement processor 50 acquires the wavelength of the laser light when the matching position (Rhg)² and the square (Rex)² of the radius of the interference fringes of the laser light coincide with each other as the offset wavelength λc, and measures the absolute wavelength λabs of the laser light based on the matching position (Rhg)², the square (Rex)² of the radius of the interference fringes of the laser light, and the offset wavelength λc.

Accordingly, by using the offset wavelength λc, the absolute wavelength λabs of the laser light can be obtained by simple calculation.

In other respects, the first embodiment is similar to the comparative example.

### 3. Spectrum Measurement Instrument 16 Including Mercury Lamp 18n Encapsulating Natural Mercury and Getter Material

### 3.1 Configuration

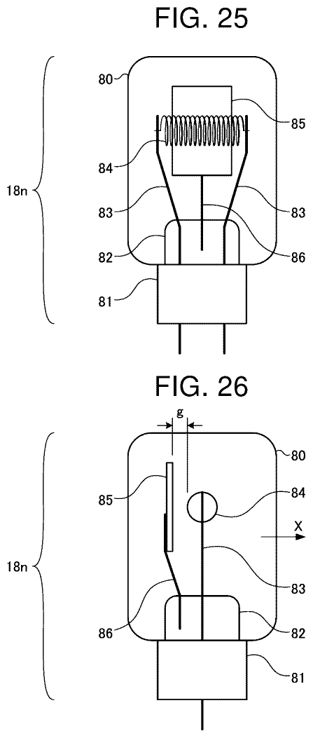

FIGS. 25 and 26 show the configuration of the mercury lamp 18n used in the laser device 1a according to a second embodiment. The configuration and operation of the laser device 1a according to the second embodiment are similar to those of the first embodiment except for the mercury lamp 18n described below. The mercury lamp 18n includes a quartz tube 80, a base 81, a flare 82, two stems 83, a filament 84, an amalgam plate 85, and a support rod 86.

The quartz encapsulates natural mercury therein. The opening of the quartz tube 80 is sealed by the base 81. The flare 82 is fixed to the base 81 inside the quartz tube 80. The two stems 83 are fixed to the flare 82. The two stems 83 pass through the flare 82 and the base 81 and are exposed to the outside of the quartz tube 80 as two electrode pins. The filament 84 as a hot cathode is fixed in the quartz tube 80 to span the two stems 83. The two stems 83 and the filament 84 form a current path inside the quartz tube 80.

The amalgam plate 85 is arranged inside the quartz tube 80 as a getter material for adsorbing natural mercury. For example, the support rod 86 is fixed to the flare 82, and the amalgam plate 85 is brazed to the support rod 86. The amalgam plate 85 is brazed to the support rod 86 on a surface of the amalgam plate 85 opposite to the surface on the filament 84 side. Amalgam means an alloy containing mercury. The amalgam plate 85 is made of, for example, an alloy of indium, silver, and natural mercury. The amalgam plate 85 has a large number of irregularities on the surface so as to have a large surface area. The amalgam plate 85 is arranged such that a shortest distance g from the filament 84 is, for example, equal to or greater than 2 mm and equal to or smaller than 6 mm. The shortest distance refers to a minimum value of a gap between objects. For example, the shortest distance between two spheres is a value obtained by subtracting the sum of the radii of the spheres from the distance between the centers of the spheres. The amalgam plate 85 is located at a position opposite to a travel direction X of the light traveling from the substantially center of the mercury lamp 18n toward the etalon 18b.

At the same ambient temperature, the vapor pressure of mercury contained in the amalgam is lower than the vapor pressure of pure mercury, so that much of the mercury encapsulated in the mercury lamp 18n is absorbed by the amalgam plate 85 when the mercury lamp 18n is turned off. When the mercury lamp 18n is turned on, mercury is released from the amalgam plate 85, but an excessive increase in the vapor pressure is suppressed. The proper range of the mercury vapor pressure is from 0.8 to 1.0 Pa. When the shortest distance g from the filament 84 to the amalgam plate 85 is shortened, the time until the proper vapor pressure is reached is shortened, and when the shortest distance g is lengthened, the time until the proper vapor pressure is reached is lengthened.

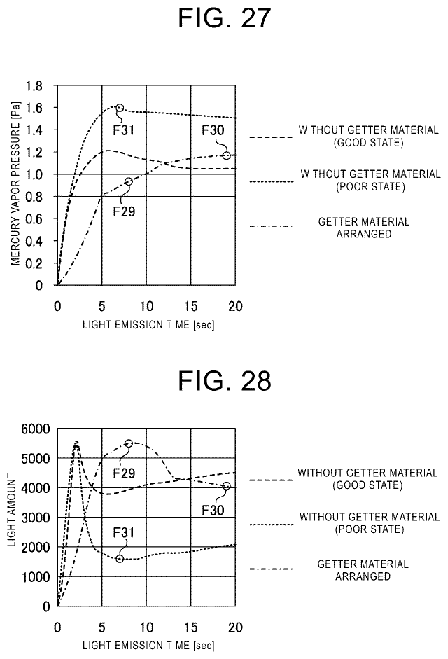

FIG. 27 is a graph showing relationships between mercury vapor pressures and light emission times from the start of light emission of the mercury lamp 18n including the getter material and the mercury lamp 18n without the getter material. The mercury lamp 18n without the getter material includes a mercury lamp 18n in a good state and a mercury lamp 18n in a poor state.

When the mercury lamp 18n without the getter material starts to emit light, the inside of the mercury lamp 18n is heated by the hot cathode, and the mercury vapor pressure in the mercury lamp 18n rapidly increases. In both the good state and the poor state, the mercury vapor pressure falls within the range from 0.8 to 1.0 Pa which is the proper vapor pressure at about 2 seconds after the start of light emission. Thereafter, the mercury vapor pressure rises and becomes supersaturated beyond the proper vapor pressure range. When the mercury vapor pressure exceeds the proper range in a short time as described above, it is difficult to obtain a stable light amount and stable interference fringes. As the reason for the rapid increase in the mercury vapor pressure, it is considered that mercury condenses in the vicinity of the hot cathode or to the hot cathode itself after the mercury lamp 18n is turned off, and is rapidly heated after the start of light emission. After about 6 seconds from the start of light emission, the mercury vapor pressure gradually decreases. However, as shown as the poor state in FIG. 27, there is a case in which the deviation from the proper vapor pressure is large even when about 20 seconds have elapsed from the start of light emission.

In the mercury lamp 18n in which the getter material is arranged, rising of the mercury vapor pressure from the start of light emission is gentle, and further, increase of the mercury vapor pressure is more gradual after about 5 seconds from the start of light emission. Consequently, the mercury vapor pressure is set to an appropriate vapor pressure from 0.8 to 1.0 Pa for a period from the time when about 5 seconds have elapsed from the start of light emission to the time when about 10 seconds have elapsed.

FIG. 28 is a graph showing relationships between light amounts and light emission times from the start of light emission of the mercury lamp 18n including the getter material and the mercury lamp 18n without the getter material.

In the mercury lamp 18n without the getter material, the light amount reaches a maximum value at the time when about 2 seconds have elapsed from the start of light emission, and thereafter, the light amount temporarily decreases, and after about 6 seconds have elapsed from the start of light emission, the light amount gradually increases. In particular, in the poor state, it can be seen that the decrease width of the light amount after about 2 seconds elapse from the start of light emission is large. In the poor state, even if the light amount gradually increases after about 6 seconds from the start of light emission, only a half or less of the light amount in the good state may be obtained.

In the mercury lamp 18n in which the getter material is arranged, rising of the light amount from the start of light emission is slightly gentle, but a high light amount is stably obtained from the time when about 5 seconds have elapsed from the start of light emission to the time when about 12 seconds have elapsed.

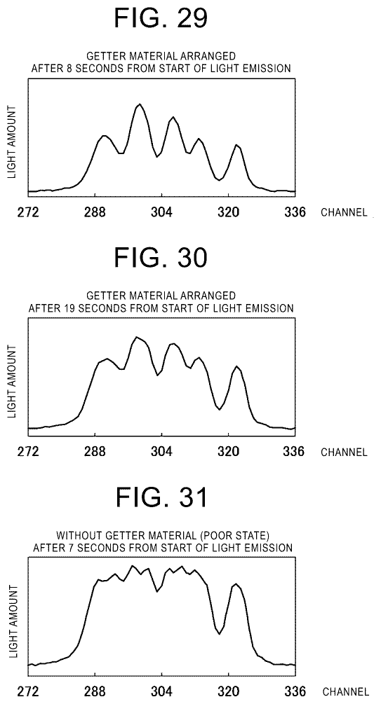

FIGS. 29 and 30 each show a waveform of interference fringes of the reference light generated using the mercury lamp 18n including the getter material. FIG. 29 shows a waveform of F29 of FIGS. 27 and 28 after 8 seconds from the start of light emission. FIG. 30 shows a waveform of F30 of FIGS. 27 and 28 after 19 seconds from the start of light emission. FIG. 31 shows a waveform of the interference fringes of the reference light generated using the mercury lamp 18n in the poor state without the getter material. FIG. 31 shows a waveform of F31 of FIGS. 27 and 28 after 7 seconds from the start of light emission.

According to the mercury lamp 18n including the getter material, a waveform with almost no noticeable collapse is obtained for at least 8 seconds from the start of light emission (see FIG. 29). When 19 seconds have elapsed from the start of light emission, the waveform is seen to be collapsed (see FIG. 30), but the five peaks are distinguishable.

In the mercury lamp 18n without the getter material, self-absorption occurs due to excessive mercury vapor pressure, and five peaks that should be included in the reference light cannot almost be seen (see FIG. 31). When the mercury lamp 18n in the poor state is caused to continuously perform light emission for about 10 minutes, for example, it is possible to reduce the amount of mercury condensed in the vicinity of the filament 84 after the light is subsequently turned off. When the light emission is started again in this state, since a large amount of mercury can be prevented from evaporating at once, the mercury lamp 18n in the good state can be obtained.

### 3.2 Effect

(10) According to the second embodiment, the mercury lamp 18n is a low-pressure mercury lamp in which the amalgam plate 85 is encapsulated as the getter material together with natural mercury.

Accordingly, by encapsulating the getter material together with natural mercury, attenuation of a plurality of peaks due to a plurality of isotopes due to self-absorption is suppressed, and the accuracy of matching by the plurality of peaks is improved. Further, by performing matching of the five peaks using natural mercury, the amount of information is increased as compared with the case in which the calculation is performed only with the resonant wavelength of a specific isotope, and highly accurate detection can be performed.

In other respects, the second embodiment is similar to the first embodiment.

### 4. Spectrum Measurement Instrument 16 with Improved SN Ratio

### 4.1 Operation

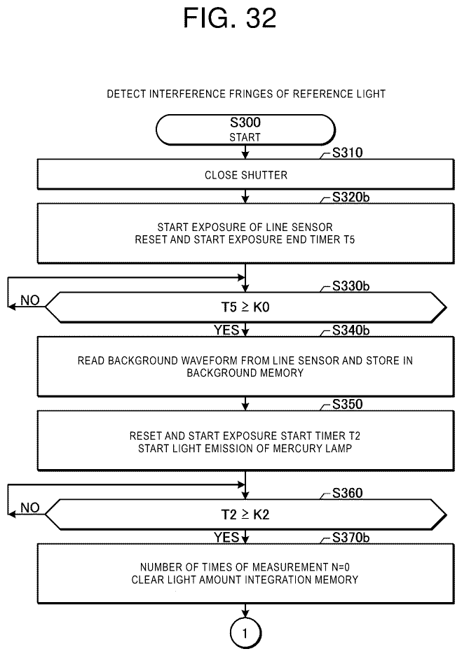

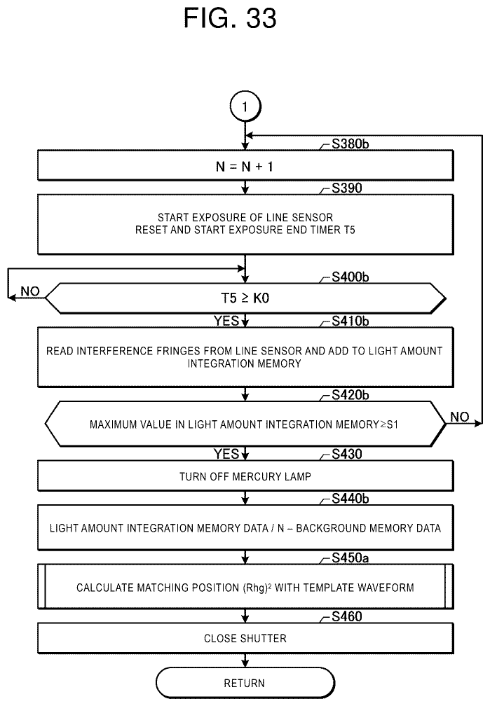

FIGS. 32 and 33 are flowcharts showing details of the processing of detecting the interference fringes of the reference light in a third embodiment. The processing shown in FIGS. 32 and 33 is performed by the wavelength measurement processor 50 as a subroutine of S300 shown in FIG. 3. Although the illustration of the laser device 1a according to the third embodiment is omitted, it is the same as the laser device 1a according to the first embodiment described with reference to FIG. 9 except that the memory 61 includes a background memory and a light amount integration memory. Referring to FIG. 32, in S310, the wavelength measurement processor 50 controls the actuator 17b so that the shutter 17a is closed and entering of the laser light is limited. This is similar to the comparative example described with reference to FIG. 4.

### 4.1.1 Acquiring Background Waveform

In S320b, the wavelength measurement processor 50 starts the exposure of the line sensor 18d and resets and starts the timer T5 for measuring the time until the exposure of the line sensor 18d ends. A difference from S390 is that the mercury lamp 18n is not turned on in S320b.

In S330b, the wavelength measurement processor 50 determines whether or not the value of the timer T5 has reached a threshold K0. The threshold K0 corresponds to the second exposure time in the present disclosure, and may be, for example, 0.5 second or more and 1 second or less. When the value of the timer T5 has not reached the threshold K0 (S330b:NO), the wavelength measurement processor 50 waits until the value of the timer T5 reaches the threshold K0, and causes the exposure of the line sensor 18d to be continued. When the value of the timer T5 has reached the threshold K0 (S330b:YES), the wavelength measurement processor 50 advances processing to S340b.

In S340b, the wavelength measurement processor 50 outputs the data output trigger to the line sensor 18d. Thus, the wavelength measurement processor 50 ends the exposure of the line sensor 18d. Further, the wavelength measurement processor 50 reads, from the line sensor 18d, observation data of the light amount in i non-lighting state as a background waveform, and stores the background waveform in the background memory. The background waveform corresponds to the third spectral waveform in the present disclosure.

### 4.1.2 Improvement of SN Ratio Due to Integration of Interference Fringes of Reference Light

In S350, the wavelength measurement processor 50 starts light emission of the mercury lamp 18n by controlling the lamp power source 18h as resetting and starting a timer T2 that measures the time from the start of light emission of the mercury lamp 18n to the start of exposure of the line sensor 18d. Further, in S360, the wavelength measurement processor 50 determines whether or not the value of the timer T2 has reached the threshold K2. These are similar to the comparative example described with reference to FIG. 4. Here, the threshold K2 may be example, 0 second or more and 2 seconds or less.

In S370b, the wavelength measurement processor 50 sets the value of the counter N for counting the number of times of measurement of the reference light to an initial value of 0. Further, the wavelength measurement processor 50 erases the data stored in the light amount integration memory.

Referring to FIG. 33, in S380b, the wavelength measurement processor 50 adds 1 to the value of the counter N to update the value of N.

In S390, the wavelength measurement processor 50 starts the exposure of the line sensor 18d and resets and starts the timer T5 for measuring the time until the exposure of the line sensor 18d ends. This is similar to the comparative example described with reference to FIG. 4.

In S400b, the wavelength measurement processor 50 determines whether or not the value of the timer T5 has reached the threshold K0. The threshold K0 is the same as the threshold K0 used in S330b. When the value of the timer T5 has not reached the threshold K0 (S400b:NO), the wavelength measurement processor 50 waits until the value of the timer T5 reaches the threshold K0, and causes the exposure of the line sensor 18d to be continued. When the the timer T5 has reached the threshold K0 value of (S400b:YES), the wavelength measurement processor 50 advances processing to S410b.

In S410b, the wavelength measurement processor 50 outputs the data output trigger to the line sensor 18d. Thus, the wavelength measurement processor 50 ends the exposure of the line sensor 18d. Further, the wavelength measurement processor 50 reads the data of the interference fringes of the reference light from the line sensor 18d, integrates the data stored in the light amount integration memory for each channel of the line sensor 18d, and updates the data of the light amount integration memory. As a result, the integrated interference fringes of the reference light are stored in the light amount integration memory.

In S420b, the wavelength measurement processor 50 determines whether or not the maximum value among the integrated light amounts for each channel of the interference fringes of the reference light has reached the threshold S1. When the maximum value is less than the threshold S1 (S420b:NO), the wavelength measurement processor 50 returns processing to S380b. When the maximum value is equal to or more than the threshold S1 (S420b:YES), the wavelength measurement processor 50 advances processing to S430.

In S430, the wavelength measurement processor 50 controls the lamp power source 18h to turn off the mercury lamp 18n. This is similar to the comparative example described with reference to FIG. 4. The value N×K0 obtained by multiplying the value of the counter N integrated up to this time by the threshold K0 is the total exposure time of the interference fringes of the reference light, and corresponds to the first exposure time in the present disclosure.

### 4.1.3 Improvement of SN Ratio Due to Subtraction of Background Waveform

In S440b, the wavelength measurement processor 50 deforms the integrated interference fringes of the reference light by subtracting the light amount of each channel of the background waveform from the value obtained by dividing the integrated light amount of each channel of the interference fringes of the reference light by N. The reason why the integrated light amount of the interference fringes of the reference light is divided by N is to align the exposure time before subtracting the light amount of the background waveform. Instead of dividing the integrated light amount of the interference fringes of the reference light by N, the light amount of the background waveform may be multiplied by N. Further, when the processes from S320b to S340b are performed between S430 and S440b, the exposure time in S330b may be set to N×K0. In this case, the integrated light amount of the interference fringes of the reference light may not be divided by N. Further, the processes from S320b to S340b and S440b may be omitted. Instead of the processes from S370b to S420b, the processes from S390 to S410 in FIG. 10 may be performed, and instead of S440b, the background waveform may be subtracted from the interference fringes of the reference light. The interference fringes obtained as described above are referred to as interference fringes of the reference light in the subsequent processing.

### 4.1.4 Pattern Matching

In S450a, the wavelength measurement processor 50 deforms the waveform of the interference fringes of the reference light into the deformed waveform I (m) corresponding to the wavelength coordinate system, and calculates the matching position (Rhg)² between the deformed waveform I (m) and the template waveform T (i). This is similar to the first embodiment described with reference to FIGS. 10 to 21.

In S460, the wavelength measurement processor 50 controls the actuator 17b to open the shutter 17a. Thereafter, the wavelength measurement processor 50 ends the processing of the flowchart, and returns to the processing of FIG. 3. These are similar to the comparative example described with reference to FIG. 4.

### 4.2 Effect

(11) According to the third embodiment, the wavelength measurement processor 50 acquires the background waveform, reduces noise included in the waveform of the interference fringes of the reference light based on the background waveform, and performs pattern matching using the noise-reduced waveform of the interference fringes of the reference light.

Accordingly, it is possible to accurately perform determination in pattern matching by reducing noise using the background waveform.

(12) According to the third embodiment, the wavelength measurement processor 50 acquires the spectral waveform output from the spectrometer 18 as the background waveform when entering of the reference light and the laser light into the spectrometer 18 is limited, deforms the waveform of the interference fringes of the reference light using the background waveform, and performs pattern matching using the waveform of the interference fringes of the deformed reference light.

Accordingly, by using the spectral waveform output from the spectrometer 18 when entering of the reference light and the laser light into the spectrometer 18 is limited, noise caused by variation of the offset signal when the light is not incident on the plurality of light receiving elements included in the line sensor 18d is reduced, enabling to perform accurate determination.

(13) According to the third embodiment, the wavelength measurement processor 50 integrates the light amount of the waveform of the interference fringes of the reference light for each channel, and performs pattern matching using the waveform of the integrated interference fringes of the reference light when the maximum value of the integrated light amount reaches the threshold S1.

Accordingly, by integrating the light amount until the threshold S1 of the light amount is reached, the light amount can be suppressed from being insufficient and from being excessive. Therefore, it is not necessary to adjust the threshold K5 (see FIG. 4) of the exposure time to suppress the light amount from being insufficient and from being excessive.

(14) According to the third embodiment, the wavelength measurement processor 50 measures the first exposure time N×K0 of the reference light while integrating the light amount of the waveform of the interference fringes of the reference light for each channel, acquires the background waveform when the exposure is performed over the threshold K0 which is a second exposure time while limiting entering of the reference light and the laser light into the spectrometer 18, and performs pattern matching using the waveform of the interference fringes of the reference light whose noise is reduced by reducing noise included in the waveform of the integrated interference fringes of the reference light based on the waveform of the integrated interference fringes of the reference light, the first exposure time N×K0, the background waveform, and the threshold K0 which is the second exposure time.

Accordingly, by adjusting the interference fringes of the reference light or the background waveform in accordance with the first exposure time N×K0 obtained by integrating the light amount of the interference fringes of the reference light and the threshold K0 which is the second exposure time for acquiring the background waveform, noise can be accurately removed.

In other respects, the third embodiment is similar to the first embodiment. Similarly to the second embodiment, the mercury lamp 18n including natural mercury and the getter material may be used.

### 5. Spectrum Measurement Instrument 16 Updating Template Waveform T (i)

### 5.1 Operation

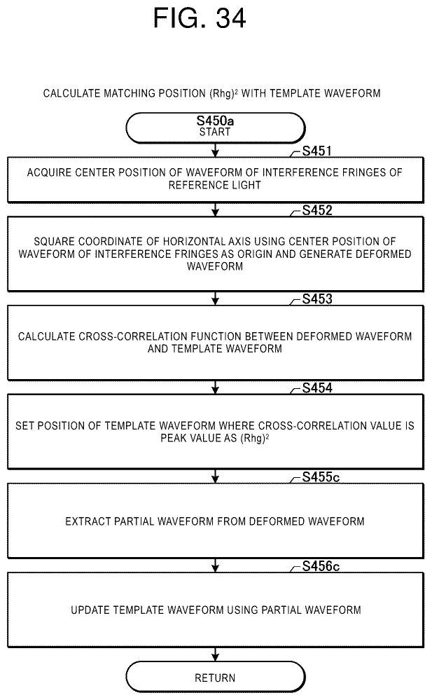

FIG. 34 is a flowchart showing details of the processing of calculating the matching position (Rhg)² in a fourth embodiment. The processing shown in FIG. 34 is performed by the wavelength measurement processor 50 as a subroutine of S450a shown in FIG. 10. The processes from S451 to S454 are similar to those of the first embodiment described with reference to FIG. 11.

In S455c, the wavelength measurement processor 50 extracts a partial waveform P (i) of the wavelength band corresponding to the wavelength band of the template waveform T (i) from the deformed waveform I (m) of the interference fringes of the reference light deformed into the waveform corresponding to the wavelength coordinate system.

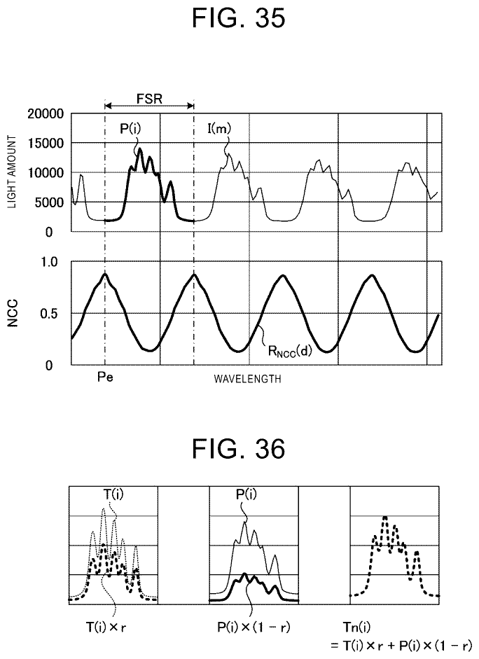

FIG. 35 is a graph for explaining a method of extracting the partial waveform P (i). In FIG. 35, the deformed waveform I (m) of the interference fringes of the reference light and the normalized cross-correlation function R_{NCC} (d) are shown on the same wavelength scale. The start point of the partial waveform P (i) extracted from the deformed waveform I (m) is the peak position Pe of the normalized cross-correlation function R_{NCC} (d). The end point of the partial waveform P (i) is determined such that the wavelength width of the partial waveform P (i) coincides with the wavelength width of the template waveform T (i). For example, the wavelength width of the partial waveform P (i) corresponds to the free spectral range of the etalon 18b.

Referring back to FIG. 34, in S456c, the wavelength measurement processor 50 updates the template waveform T (i) stored in the memory 61 using the partial waveform P (i).

FIG. 36 is a graph for explaining a method of updating the template waveform T (i) using the partial waveform P (i). A weighted waveform T (i)×r and a weighted waveform P (i)×(1−r) are calculated by multiplying the template waveform T (i) stored in the memory 61 and the partial waveform P (i) extracted in S455c by weights r and 1−r, respectively, and a waveform obtained by adding these weighted waveforms is set as a new template waveform Tn (i).

### 5.2 Effect

(15) According to the fourth embodiment, the wavelength measurement processor 50 updates the template waveform T (i) based on the waveform of the interference fringes of the reference light deformed into the deformed waveform I (m) corresponding to the wavelength coordinate system.

Accordingly, it is possible to perform accurate measurement even when the characteristics of the mercury lamp 18n are changed by updating the template waveform T (i) using the measured value of the interference fringes of the reference light.

(16) According to the fourth embodiment, the wavelength measurement processor 50 extracts the partial waveform P (i) corresponding to the wavelength band of the template waveform T (i) from the deformed waveform I (m), and updates the template waveform T (i) based on the partial waveform P (i).

Accordingly, by matching the wavelength band of the partial waveform P (i) with the wavelength band of the template waveform T (i), it is possible to accurately update the template waveform T (i).

(17) According to the fourth embodiment, the wavelength measurement processor 50 acquires the relationship between the shift amount d between the deformed waveform I (m) and the template waveform T (i) and the cross-correlation value between the deformed waveform I (m) and the template waveform T (i), and extracts, as the partial waveform P (i), a portion of the deformed waveform I (m) having a width corresponding to the width of the template waveform T (i) based on the relationship.

Accordingly, an appropriate partial waveform P (i) corresponding to the width of the template waveform T (i) can be extracted from the deformed waveform I (m).

(18) According to the fourth embodiment, the wavelength measurement processor 50 updates the template waveform T (i) by adding the partial waveform P (i) and the template waveform T (i) after performing weighting on each thereof.

Accordingly, by taking the partial waveform P (i) and the template waveform T (i) before updating into account, it is possible to suppress abrupt fluctuation of the template waveform T (i).

In other respects, the fourth embodiment is similar to the first embodiment. Similarly to the second embodiment, the mercury lamp 18n including natural mercury and the getter material may be used. Further, similarly to the third embodiment, the interference fringes of the reference light may be integrated or the background waveform may be subtracted until the integrated light amount exceeds a certain value.

### 6. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A spectrum measurement instrument configured to measure a wavelength of pulse laser light, comprising:
a mercury lamp configured to encapsulate natural mercury including a plurality of isotopes and output reference light;
a spectrometer located on an optical path of the reference light and the laser light and configured to receive the reference light and output a first spectral waveform; and
a processor being accessible to a template waveform of a spectrum including a plurality of peaks of a known waveform of the reference light, and configured to perform pattern matching using the first spectral waveform and the template waveform and identify a first peak position corresponding to one of the plurality of peaks of the first spectral waveform.

2. The spectrum measurement instrument according to claim 1,
wherein the spectrometer outputs a waveform of interference fringes of the reference light formed using an etalon as the first spectral waveform, and
the processor deforms the first spectral waveform by transforming the waveform of the interference fringes of the reference light into a waveform corresponding to a wavelength coordinate system, and identifies the first peak position by identifying a matching position of the deformed first spectral waveform matched to the template waveform.

3. The spectrum measurement instrument according to claim 2,
wherein the processor determines a center position of the interference fringes of the reference light based on a relationship between an inverted first portion and a second portion obtained by dividing the waveform of the interference fringes of the reference light into a first portion and the second portion and inverting the first portion, and transforms the waveform of the interference fringes of the reference light in accordance with a distance from the center position.

4. The spectrum measurement instrument according to claim 3,
wherein the processor determines the center position based on a cross-correlation value between the inverted first portion and the second portion.

5. The spectrum measurement instrument according to claim 4,
wherein the processor acquires a relationship between a division position for dividing the waveform of the interference fringes of the reference light into the two portions and the cross-correlation value, and determines the center position based on the relationship between the division position and the cross-correlation value.

6. The spectrum measurement instrument according to claim 2,
wherein the processor identifies the matching position based on a cross-correlation value between the deformed first spectral waveform and the template waveform.

7. The spectrum measurement instrument according to claim 6,
wherein the processor acquires a relationship between a shift amount between the deformed first spectral waveform and the template waveform and the cross-correlation value, and identifies the matching position based on the relationship between the shift amount and the cross-correlation value.

8. The spectrum measurement instrument according to claim 2,
wherein the spectrometer receives the laser light and outputs a second spectral waveform, and
the processor measures an absolute wavelength of the laser light based on the matching position and a second peak position in the second spectral waveform.

9. The spectrum measurement instrument according to claim 2,
wherein the spectrometer receives the laser light and outputs a second spectral waveform, and
the processor acquires a wavelength of the laser light when the matching position and square of a radius of the interference fringes of the laser light coincide with each other as an offset wavelength, and measures an absolute wavelength of the laser light based on the matching position, the square of the radius of the interference fringes of the laser light, and the offset wavelength.

10. The spectrum measurement instrument according to claim 1,
wherein the mercury lamp is a low-pressure mercury lamp in which a getter material is encapsulated together with natural mercury.

11. The spectrum measurement instrument according to claim 1,
wherein the processor acquires a third spectral waveform, reduces noise included in the first spectral waveform based on the third spectral waveform, and performs the pattern matching using the noise-reduced first spectral waveform.

12. The spectrum measurement instrument according to claim 1,
wherein the processor acquires a spectral waveform output from the spectrometer as a third spectral waveform when entering of the reference light and the laser light into the spectrometer is limited, deforms the first spectral waveform using the third spectral waveform, and performs the pattern matching using the deformed first spectral waveform.

13. The spectrum measurement instrument according to claim 1,
wherein the processor integrates a light amount of the first spectral waveform for each channel, and performs the pattern matching using the integrated first spectral waveform when a maximum value of the integrated light amount reaches a threshold.

14. The spectrum measurement instrument according to claim 1,
wherein the processor measures a first exposure time of the reference light while integrating a light amount of the first spectral waveform for each channel, acquires a third spectral waveform when exposure is performed over a second exposure time while limiting entering of the reference light and the laser light into the spectrometer, and performs the pattern matching using the first spectral waveform whose noise is reduced by reducing the noise included in the integrated first spectral waveform based on the integrated first spectral waveform, the first exposure time, the third spectral waveform, and the second exposure time.

15. The spectrum measurement instrument according to claim 1,
wherein the processor updates the template waveform based on the first spectral waveform deformed into a waveform corresponding to a wavelength coordinate system.

16. The spectrum measurement instrument according to claim 15,
wherein the processor extracts a partial waveform corresponding to a wavelength band of the template waveform from the deformed first spectral waveform, and updates the template waveform based on the partial waveform.

17. The spectrum measurement instrument according to claim 16,
wherein the processor acquires a relationship between a shift amount between the deformed first spectral waveform and the template waveform and a cross-correlation value between the deformed first spectral waveform and the template waveform, and extracts, as the partial waveform, a portion of the deformed first spectral waveform having a width corresponding to a width of the template waveform based on the relationship between the shift amount and the cross-correlation value.

18. The spectrum measurement instrument according to claim 16,
wherein the processor updates the template waveform by adding the partial waveform and the template waveform after performing weighting on each thereof.

19. A laser device comprising a spectrum measurement instrument including:
a mercury lamp configured to encapsulate natural mercury including a plurality of isotopes and output reference light;
a spectrometer located on an optical path of the reference light and laser light and configured to receive the reference light and output a first spectral waveform; and
a processor being accessible to a template waveform of a spectrum including a plurality of peaks of a known waveform of the reference light, and configured to perform pattern matching using the first spectral waveform and the template waveform and identify a first peak position corresponding to one of the plurality of peaks of the first spectral waveform.

20. A method of identifying a peak position of reference light, comprising:
acquiring a first spectral waveform as causing the reference light output from a mercury lamp encapsulating natural mercury including a plurality of isotopes to enter a spectrometer;
reading a template waveform of a spectrum including a plurality of peaks of a known wavelength of the reference light; and
performing pattern matching using the first spectral waveform and the template waveform and identifying a first peak position corresponding to one of the plurality of peaks of the first spectral waveform.
